(19) United States
(12) Patent Application Publication
(10) Pub. No.: US 2009/0080852 A1
(43) Pub. Date: Mar. 26, 2009

(54) Audiovisual Censoring

(76) Inventor: Mark E. Peters, Chapel Hill, NC (US)

Correspondence Address: Steven E. Bach Attorney at Law, 10 Roberts Road, Newtown Square, PA, 19073, US

(21) Appl. No.: 11/859,782

(22) Filed: Sep. 23, 2007

(51) Int. Cl. G11B 27/00; H04N 5/93; H04N 7/00; H04N 7/16

(52) U.S. Cl. 386/52; 386/46; 725/25; 725/28

(57) ABSTRACT

A method, apparatus, system and program product are provided for selectively censoring recorded program content while displaying a program. The method comprising the steps of: in response to a first input, identifying a first boundary; in response to a second input, identifying a second boundary; and censoring the content between the first boundary and the second boundary. A method for displaying a censored program excluding censored program content, comprises the steps of: playing a program for which a start point and an end point for censoring are identified; in response to reaching the start point, skipping program content; and in response to reaching the end point, resuming playing the program.

### FIELD OF THE INVENTION

The invention relates to the field of video devices and more particularly to an apparatus, method and program product for selectively restricting access to or deleting portions of a recorded program.

### BACKGROUND

It is often desirable for parents to control the content of broadcast, cable and satellite audiovisual programming viewed by their children. To accomplish this goal, V-chips and parental control products have been developed that block transmission of shows individually selected or matching content criteria codes selected by the parent. With these products, the blocking can be overridden by entering a code into either the television or set-top box. These solutions have, however, only allow a program to be blocked or viewed in its entirety.

Many programs that are of interest to children are generally acceptable to parents, but may contain specific scenes that are inappropriate for viewing by the children in the household. In such cases, the V-chip and parental control products only afford the parents with the options of blocking or allowing the generally acceptable programs that may contain specific objectionable scenes or content.

One alternative in this case is for the parents to pre-view the program and re-watch the program with the children, fast forwarding through objectionable scenes. This approach has several drawbacks. The parents must watch the program twice, once to identify objectionable scenes and again to fast forward through the objectionable scenes. Moreover, the parent must recognize the placement of the objectionable scene before reaching it in order to fast forward through the entire objectionable scene.

It is desirable to provide a way to limit or prevent viewing of objectionable content within a program while allowing viewing of the rest of the program.

### SUMMARY

In an exemplary embodiment, the invention provides a method for selectively censoring recorded program content while displaying a program. The method comprising the steps of: in response to a first input, identifying a first boundary; in response to a second input, identifying a second boundary; and censoring the content between the first boundary and the second boundary. A method for displaying a censored program excluding censored program content, comprises the steps of: playing a program for which a start point and an end point for censoring are identified; in response to reaching the start point, skipping program content; and in response to reaching the end point, resuming playing the program.

According to additional embodiments, the invention may provide an apparatus and a program product. The apparatus comprises: a processor adapted to execute a program of instructions; a program file of audiovisual content encoded on a memory; and a program of instruction encoded on a memory and comprising the steps of: playing a program; in response to a first input, identifying a first boundary for censoring program content; in response to a second input, identifying a second boundary for censoring program content; determining which of said boundaries is a start point; and saving the boundaries as a start point and an end point. The program product may comprise a machine readable media having encoded thereon: a first program instruction to play a program; a second program instruction to identify a first boundary in response to a first input; a third program instruction to identify a second boundary in response to a second input; a fourth program instruction to associate the first censoring boundary with the second censoring boundary; and a fifth program instruction to censor the content between the first boundary and the second boundary. Another program product may comprise a machine readable media having encoded thereon: an identification of a start point adapted to cause a program playing device to begin skipping content of a program; and an identification of an end point adapted to cause a program playing device to resume playing content of the program.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of an apparatus according to an exemplary embodiment of the present invention;

FIG. 2 is a block diagram of a system according to another exemplary embodiment of the present invention;

FIG. 3 is a flow diagram showing an implementation of the invention identifying one or more pairs of a start point and an end point for censoring according to an exemplary embodiment of the invention;

FIG. 4 is a flow diagram showing an implementation of the invention identifying one or more pairs of a start point and an end point for censoring according to another exemplary embodiment of the invention;

FIG. 5 is a flow diagram showing an implementation of the invention identifying one or more pairs of a start point and an end point for censoring according to another exemplary embodiment of the invention;

FIG. 6 is a flow diagram showing an implementation of the invention identifying one or more pairs of a start point and an end point for censoring according to another exemplary embodiment of the invention;

FIG. 7 is a flow diagram showing an implementation of the invention identifying one or more pairs of a start point and an end point for censoring according to another exemplary embodiment of the invention;

FIG. 8 is a flow diagram showing an implementation of the invention identifying one or more pairs of a start point and an end point for censoring according to another exemplary embodiment of the invention;

FIG. 9 is a flow diagram showing an implementation of the invention censoring program content between identified start and end points according to an exemplary embodiment of the invention; and

FIG. 10 is a flow diagram showing an implementation of the invention censoring program content between identified start and end points according to an exemplary embodiment of the invention.

### DETAILED DESCRIPTION

The present invention provides a method, system, apparatus and program product for selectively censoring program content. In an exemplary embodiment of the invention, a user identifies a pair of boundaries, which enclose the content to be censored. For example, while viewing a program and recording the program to a recording device, such as a set-top box, a DVR, or the like, a user determines that a particular portion of the program should be censored. The user then provides an input to a processor which may be located in the recording device, at remote location in a distributed network, in a computer, or at another suitable location. The input may be entered through a user input device, such as a remote control unit, a keyboard, or any other suitable input device. In the example of a remote control, the input can be provided by depressing a special purpose key or any key temporarily assigned the input function.

In one or more exemplary embodiments of the invention, the user input may be provided while viewing the program in a normal play mode, in a fast forward mode, in a rewind mode, or any other mode which allows the user to ascertain the program content. While watching a program, a user can provide an input to identify one boundary of content to be censored and another input to identify the other boundary of content to be censored. In one or more exemplary embodiments one or more additional pairs of boundaries may be identified.

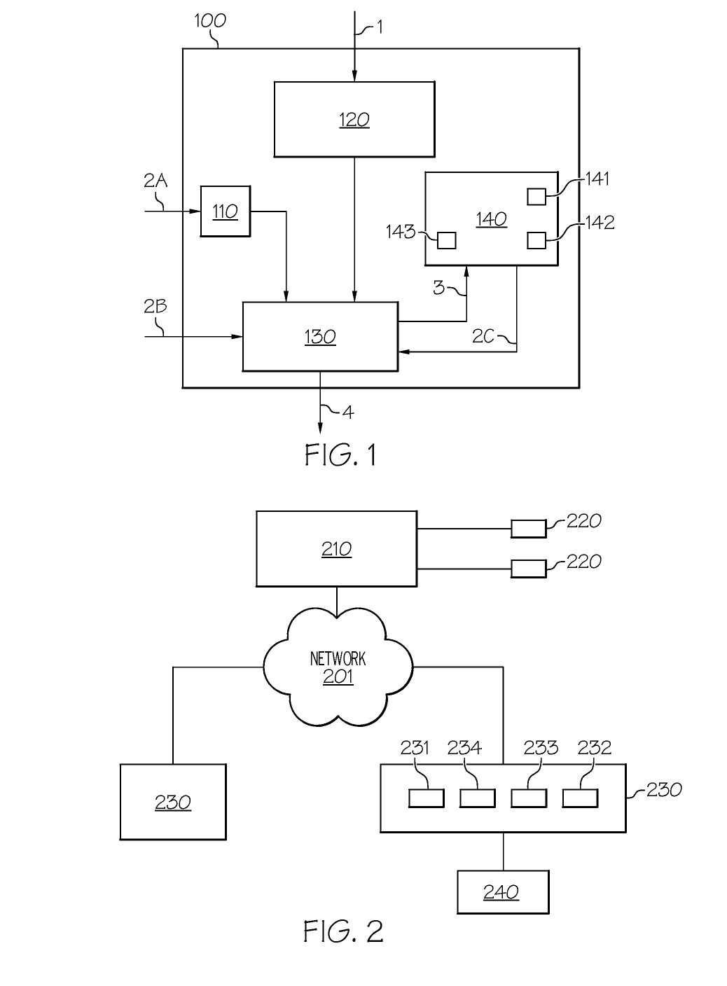

Referring now to FIG. 1, a device 100 for playing audio and/or video programs such as a set-top box, DVR, CD player, PC, or other device usable to play content to speakers and/or one or more displays is shown. The device 100 comprises a processor 130 operably associated with a memory 140 and a user interface device 120. The user interface device 110 is adapted to receive input signals 1 from a user. The user interface device may be, for example, an rf receiver adapted to receive rf signals from a remote control device. Alternatively, the user interface device 120 may be any receiver or processor capable of receiving a user input. Moreover, the user interface device 120 may be partially or fully integral with the processor 130. For example, the interface device may be a universal serial port for connecting a keyboard or mouse device to the processor 130 through a universal bus.

The processor 130 receives a signal or data stream containing program content. This signal or data stream may be, for example, a signal 2A, from a drive 110 used to read the program content from a portable memory device, such as a DVD, CD, or the like. Alternatively the signal or data stream may be a transmission signal 2B from a satellite receiver, cable connection, television broadcast, or the like. In another alternative example, the signal or data stream may be a pre-recorded data signal 2C from a memory 140 internal to or accessible to the device 100. Moreover the program may be recoded to memory 140 as a program file 141 as a recorded signal or data stream 3, or the program may be recorded to another memory separate from the program of instruction or the program may be presented through the processor 130 to a display and or speakers (not shown) via a program signal 4, or both.

The processor 130 also executes a program of instruction 143 which may be stored in memory 140, which memory may also contain the program file 143 and/or censoring files 142 as shown or may be stored in a memory separate from the program file 141 and/or censoring files 142 which will be described later. The program of instruction 143 may comprise instructions for identifying one or more pairs of start and end points for censoring program content, instructions for playing a program without censored content, or both, as will be described in detail below.

The program of instruction 143 may include steps to define censored content which may be enabled or executed while a program is displayed. These steps may comprise: in response to a first input, identifying a first boundary; in response to a second input, identifying a second boundary; and censoring the content between the first boundary and the second boundary. The step of censoring the content may include marking the start and end points with metadata on a recording of the program to cause the content to be skipped during replay of the program. Alternatively, the censoring step may include saving identification of the start point and end point, such as, for example, frame numbers, time stamps, images or image digests, or other identifying attributes which can be utilized during playback to cause the censored content to be skipped.

The program of instruction 143 may alternatively or additionally comprise steps to recognize the start and end points during playback of the recorded program and to skip the censored program content (i.e., the content between the boundaries). Thus, while playing a program for which a start point and an end point for censoring are identified, the program of instruction in response to reaching the start point, starts skipping program content, and in response to reaching the end point, the program of instruction resumes playing the program.

A system for recording and displaying programs excluding censored program content comprising a distributed network is shown in FIG. 2. In an exemplary embodiment, clients 230 are connected, through a network 201 to a server 210 that can access and download program files 220 to the clients 230. The program files 220 may be stored on the server, or more typically will be located remotely on a storage device. A client 230 requests a specific program and the program file 220 of the requested program is downloaded by the server 210 through the network 201 to the requesting client 230. The client 230 then presents the content of the program file 220 as a signal or data stream to a display 240 which may comprise a video display, speakers, or both.

A processor 231 is adapted to execute a program of instruction 232. The processor 231 and the program of instruction 232 may both be located in the client as shown in FIG. 2. However, either the processor 231, the program of instruction 232, or both may be located in the server 210 or at another location remote from the client 230 and the server 210. The processor 231 is adapted to execute the program of instructions 232 to perform the steps of: playing a program; in response to a first input, identifying a first boundary for censoring program content; in response to a second input, identifying a second boundary for censoring program content; determining which of said boundaries is a start point; and censoring the program content between the start point and the end point.

An altered program file 233 may be saved to facilitate displaying the program without the censored content. For example, the censored content may be deleted. Alternatively, the censored file may have metadata inserted at the start point and end point for each instance of censored content, such that the processor 231 can skip the censored content. In still another alternate embodiment, the start point and end point may be identified by a frame number, a time stamp, or one or more images or image digests, saved on the altered program file 233. The altered program file may be saved in the client 230 as shown, or on the server or remotely.

In another exemplary embodiment, the start point and end point identifiers may be saved in a censoring file 234, which is separate from the program file 233, as shown in FIG. 2. The start point and end point identifiers may comprise frame numbers, time stamps, images or image digests. The censoring file 234 may contain one or more pairs of start point and end point identifiers. The censoring file may be located in a memory device within the client 230, as shown, or alternatively, may be located in a memory on the server or remotely. Moreover, the censoring files may be transmitted through the network 201 and shared between clients 230 to view a program without censored program content as identified in the censoring file 234.

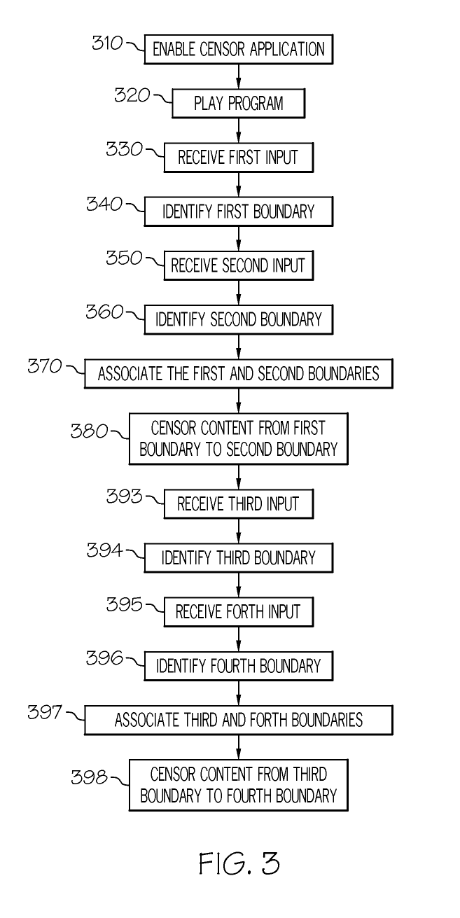

A method for censoring program content is shown in FIG. 3 according to an exemplary embodiment of the invention. In this exemplary embodiment, the method is realized in a censor application or program of instruction which is responsive to user initiated stimuli. The censor application is initiated (step 310). The application may be initiated by a command or user input applied through a remote control or the like. Alternatively, the application may be initiated as a default setting of an apparatus or system for recoding and/or playing recorded program content.

With the censor application enabled, the program is played (step 320). The program may be played for example in response to a user command or input. The program may be played in normal play mode, in fast forward mode, in rewind mode, or in any other mode which allows the user to ascertain the program content and determine any content that the user chooses to censor (i.e., that content to which the user wishes to prevent or limit access). The program can be played while it is being recorded for future use, or it can be played from a solid state memory or a memory drive, or the like.

A user provides an input at a boundary (i.e., the beginning or end) of a portion of program content to be censored. For example, while viewing and recording a program from a cable broadcast, a viewer determines that a particular portion of the content is not suitable for younger viewers who will be watching the recorded program. Accordingly, the user provides an input, such as depressing a button or key on a remote control having the censoring function assigned to it. The censoring function may be temporarily assigned by the program of instruction or the button or key may be dedicated to this function. The user provides another input at the other boundary of the content to be censored.

In an exemplary embodiment, the user identifies the boundaries in a specific order, while in another exemplary embodiment, the user may identify the boundaries in either order. That is, the user may first identify the end point. Thus, the user while viewing content determines content which the viewer desires to censor, and the user identifies a boundary when the objectionable content is completed (i.e., the end point). The user can then rewind the recorded program until the beginning of the objectionable content is reached (i.e., the start point) and identify the other boundary. It should be noted that in an exemplary embodiment the boundaries may be identified while in a normal play mode, a fast forward mode, a rewind mode, or any other mode that allows the user to ascertain the content of the program. Moreover, the censoring application may be executed while a program is simultaneously viewed and recorded or while the program is viewed from a recorded media.

The application receives a first input from the user (step 330) when the program reaches a point at which the user wishes to begin or end the censoring. In response to the first input from the user, the application identifies a first boundary (step 340). The first boundary, as described above can be the point in the program content when the censoring is to begin or the point where the censoring is to end. Also, the first boundary may be identified by a frame number corresponding to one of a sequential series of frames that are displayed in order to play a program. Alternatively, the first boundary may be identified by a time stamp, by one or more images or image digests, or by any other means that serves to differentiate a specific point in the program. In et another alternate identification, the first boundary may be identified by inserting metadata onto the program at the boundary point.

The application receives a second input from the user (step 350) when the program reaches a point at which the user wishes to begin or end the censoring (i.e., the opposite boundary point for the censored content from the first boundary). In response to the second input from the user, the application identifies a second boundary (step 360). Together, the pair of the first and second boundaries defines the censored content between them.

In an exemplary embodiment, the first and second boundaries are associated with each other (step 370). Thus, for example, when a first boundary is identified in step 340, the application waits for a second boundary to be identified to create a pair of boundaries. In this way, the application can associate the two boundaries and determine which boundary is the start point and which boundary is the end point by comparing frame numbers, time stamps, or the like.

The content between the first and second boundaries is censored (step 380). The content may be censored in any manner which prevents or limits access to the censored content when the program is replayed from memory. For example, a portion of program content may be deleted after the first boundary is identified and until the second boundary is identified, or the program content between the boundaries may be deleted after the pair of boundaries are identified.

Alternatively the program content between the first and second boundaries may be censored by enabling an apparatus or system replaying the recorded program to locate the start and end point boundaries during playback and selectively skip the program content between the start point and the end point, as will be described below. The start point and end point may be located by inserting metadata on the program at the start point and the end point, the metadata being readable by the apparatus or system playing the program from memory.

In another exemplary embodiment, the start point and end point are located by saving a unique parameter of the boundary points, such as frame numbers, time stamps, or images or image digests. For example, a program that plays at 30 frames per second may have each frame identified by a unique sequential frame number. The frame numbers can be used by an application to cause an apparatus or system for playing the program to identify a particular point to start or end a playback. Thus, censoring content between the first and second boundaries may comprise saving the frame numbers for the boundaries to be used during playback to skip frames between the pair of boundaries. Similarly, the unique parameter may be a time stamp which is saved during recording of a program to identify the time at which it was originally broadcast. The time stamps may be saved and used by the application to cause the program content between the boundaries to be selectively skipped.

Yet another unique parameter for identifying boundary points is to save an image or an image digest from one or more frames at the start and at the end of a portion of program content to be censored. An image is a digital representation of a frame or a refresh cycle from a program, and a digest of an image is a smaller digital record having less data but containing data usable for image matching such as a thumbnail with fewer pixels but the same pattern or another version of the image having less data. Inages or image digests corresponding to the start point and end point for censoring can be saved. By comparing images during playback with the saved boundary images or image digests, the application can cause the program content between the boundaries to be selectively skipped.

As illustrated in FIG. 3, the application may identify more than one pair of boundaries, thereby skipping more than one portion of program content. As shown in FIG. 3 a third input is received (step 393) from the user during play of the program corresponding to a second portion of program content to which the user wishes to prevent or limit access. As with the first censored content, the third input may correspond to either the beginning or the end of the censored content or may be a specific boundary depending upon the particular embodiment.

In response to the third input, the application identifies a third boundary point in the program content (step 394). Similarly, a fourth input is received from the user (step 395) and a fourth boundary is identified (step 396). Thus, the third and fourth boundaries comprise a second pair of boundary points identifying a second portion of program content to be censored between the boundary pair. The third and fourth boundaries are associated as a boundary pair (step 397), and program content between the boundary pair is censored (step 398).

The user may continue to provide inputs to identify boundary pairs, thereby censoring additional portions of program content. Each pair of boundaries is associated to define censored content there between. As with the program content between the first boundary pair, the content between each pair of boundaries may be censored by the application using deletion, saving boundary identification for use by an application during playback to skip the censored content, or by inserting metadata to cause the censored content to be selectively skipped.

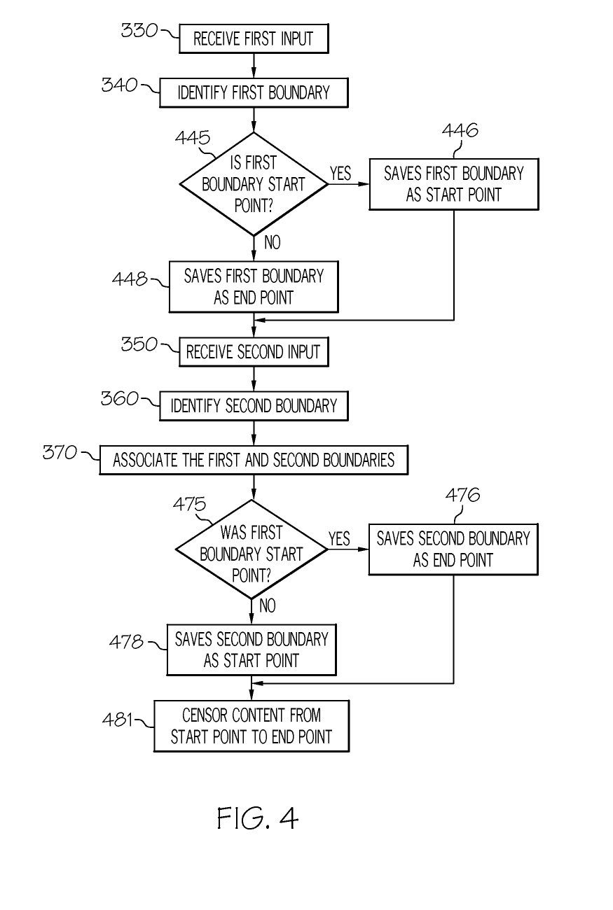

Another exemplary embodiment of the invention is shown in FIG. 4. In this embodiment, the application receives a first input from a user (step 330) who is viewing and/or listening to the program in any of a variety of play modes as in the exemplary embodiment shown in FIG. 3. In response to the first input, the application identifies a first boundary (step 340). As in earlier embodiments, the first boundary may be identified in a variety of ways, such as inserting metadata or saving a frame number, time stamp, or image or image digest.

In the exemplary embodiment illustrated in FIG. 4, the application determines whether or not the first boundary is a start point for censoring (step 445). This can be done in a variety of ways. For example, the system can query the user using a menu driven query that the user answers by moving up or down through a menu of answers (e.g., start censor and end censor) and selecting a response by depressing an enter button or key on a remote control. If the first boundary is determined to be the start point for censoring a portion of program content, the application saves the first boundary as a start point (step 446). The start point may be saved in the program content file or in a separate censoring file that may be stored and transmitted independently of the program content file. In the illustrated example the boundary is saved as a start point (step 446), however, the first boundary could alternatively be identified as a start point for censoring a portion of program content by inserting start point metadata onto the recorded program file at the first boundary.

If the application determines in step 445 that the first boundary is not a start point for censoring a portion of program content, then the first boundary is saved as an end point (step 448). As with the start point, the end point could alternatively be identified by inserting end point metadata onto the recorded program file at the first boundary.

As the user continues to view/listen to the program, the user provides a second input at the beginning/end of the program content to be censored. The application receives the second input (step 350) and, in response, identifies a second boundary (step 360). The second boundary is associated with the first boundary (step 370) to form a pair of boundaries that define censored content there between. Each portion of censored content has a beginning and an end, and therefore boundaries need to be associated into pairs, so that each pair defines a single portion of censored content.

The application determines through association of a pair of boundaries whether the first boundary in the pair was a start point (step 475). If so, then the second boundary is saved as an end point (step 476). If not, then the second boundary is saved as a start point (step 478). Thus the pair of boundaries comprises a start point and an end point for censoring. As described previously, the start point and end point may be identified by insertion of metadata rather than being saved. Also, the start point and end point may be saved as frame numbers, time stamps, or images or image digests.

Having identified a pair of boundaries and saved them as a start point and an end point, the application censors program content from the start point to the end point (step 481). This censored content may be deleted, or the content may be censored by selectively skipping it when an application recognizes the start point and resuming presentation of program content when an application recognizes the end point.

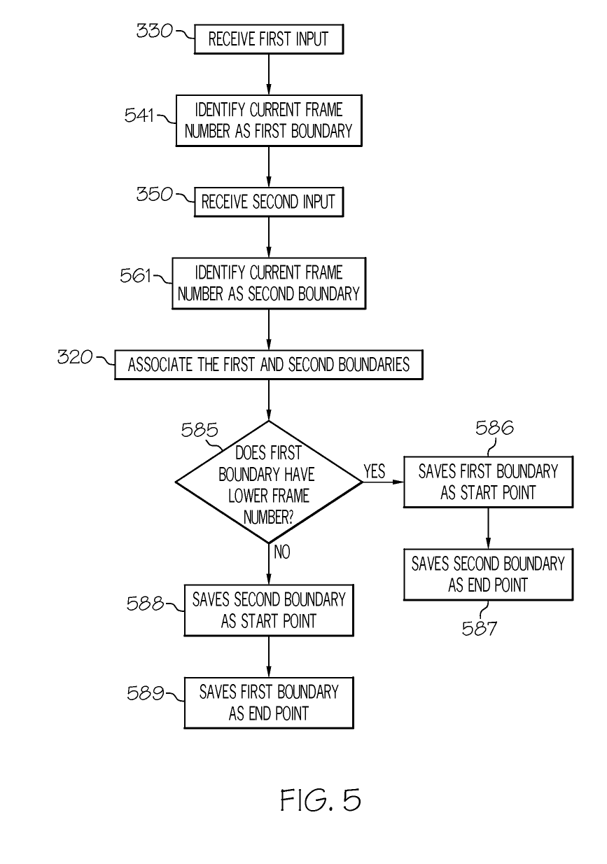

FIG. 5 illustrates an exemplary embodiment in which the boundaries are defined as frame numbers and the application determines the start point and end point by comparison of frame numbers. While a user is viewing/listening to program content, the user provides and the application receives a first input (step 330). In response to the first input, the application identifies the current frame number as a first boundary (step 541). That is, the frame number being displayed when the first input is received is calculated or captured. This frame number may be saved, for example in a censoring file or on the program content file.

The user subsequently provide a second input, and the application receives the second input (step 350). In response to the second input, the application identifies the current frame number as the second boundary (step 561). That is the frame number of the frame or screen image that is being displayed when the second input is received, is calculated or captured and the second boundary is set at this frame number. The first and second boundaries are then associated to form a pair of boundaries (step 370).

The application compares the first and second boundaries to determine which is the lower frame number (step 585). If the first boundary is the lower frame number, then the first boundary is saved as a start point (step 586) and the second boundary is saved as an end point (step 587), defining censored program content from the start point to the end point to be selectively skipped during replay. If the first boundary is not the lower frame number, then the second boundary is saved as a start point (step 588) and the first boundary is saved as an end point (step 589), defining censored program content from the start point to the end point to be selectively skipped during replay.

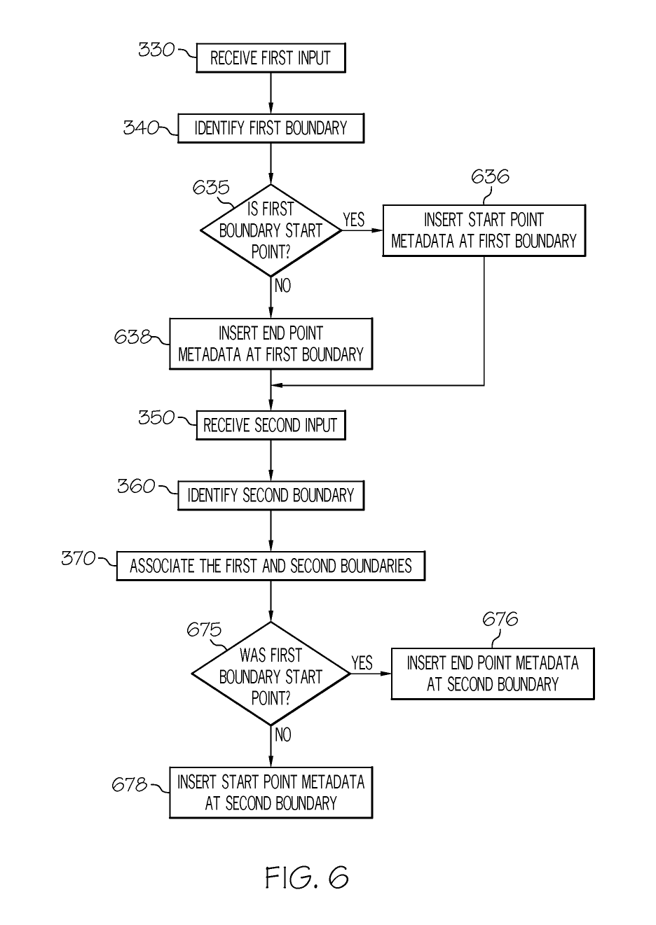

FIG. 6 illustrates an exemplary embodiment of the invention in which first and second boundaries are identified by inserting metadata onto the program content at the beginning and end of the content to be censored, and in which the start point is determined by querying the user. As with previous exemplary embodiments, the application receives a first input from the user (step 330) who is viewing/listening to the program content and determines that a portion of program content should be censored. In response to the first input, the application identifies a first boundary (step 340). In this embodiment the first boundary is identified as point in the program content being displayed when the first input is received. The application then queries the user on whether or not the first boundary is the start point for censoring. If so, then the application inserts start point metadata at the first boundary (step 636). If not, then the application inserts end point metadata at the first boundary (step 638).

The application receives a second input (step 350). In response to the second input, the application identifies a second boundary (step 360) and associates the first and second boundaries (step 370) to form a boundary pair. The application determines whether the boundary pair already has a start point (step 675) based on the earlier determination for the first boundary. If so, then the application inserts end point meta data at the second boundary (step 676). If not, then the application inserts start point meta data at the second boundary (step 678).

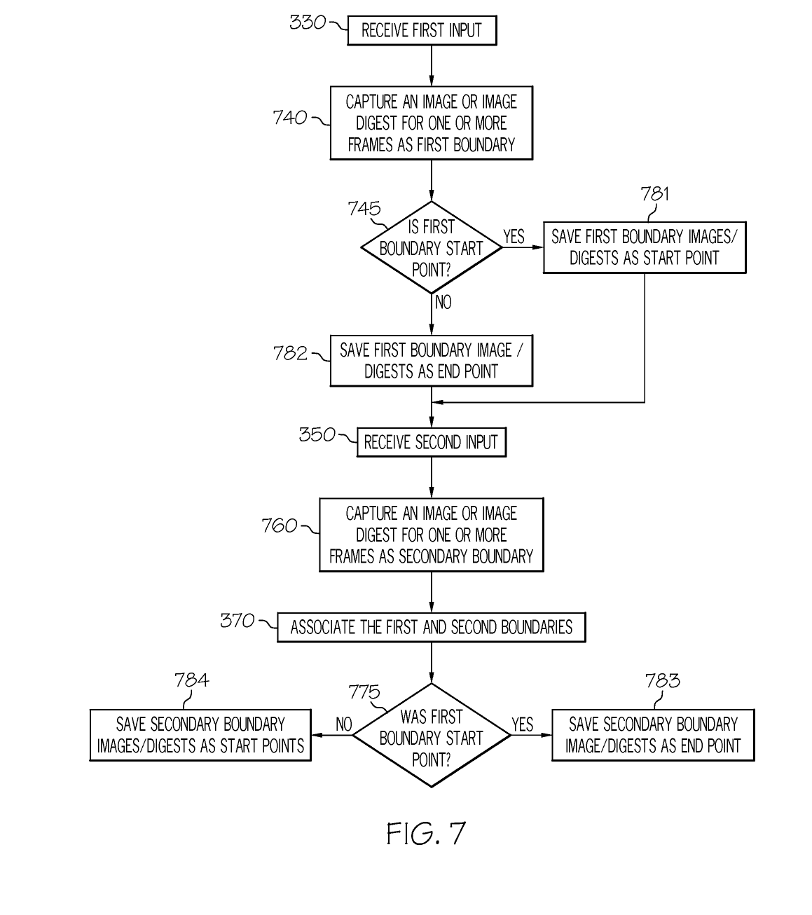

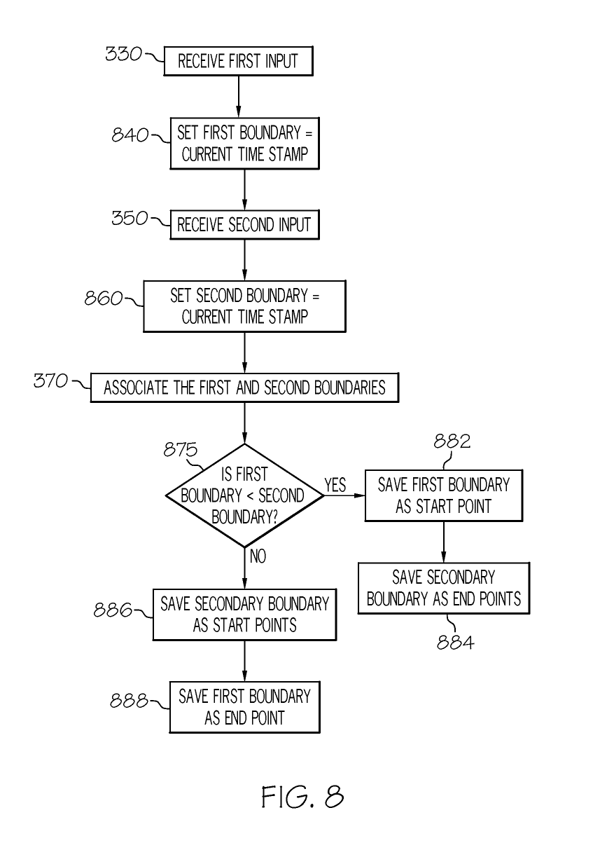

FIG. 7 illustrates an exemplary embodiment in which images or image digest are captured to identify first and second boundaries. In the illustrated example, the start point is determined by querying the user, however the start point may alternatively be determined by comparison of frame numbers or time stamps which would then need to be calculated or captured with the images or digests. In this exemplary embodiment, the images or digests of the images from one or more frames being displayed when the first input is received and in response to receiving the first input are captured as a first boundary (step 740). As described previously, images may be digital representations of a single frame or single refresh cycle of a streaming video signal. Digests may be truncated or reduced versions of the images comprising for example, fewer pixels.

The application queries the user on whether or not the first boundary is a start point for censoring (step 745). If so the first boundary images or digests are saved as a start point (step 781). If not, then the first boundary images or digests are saved as an end point for censoring (step 782). The start point and end point images or digests may be saved to a censoring file which can be stored and shared independently of the program content. For example, censoring files may be saved and distributed on a web site for parent interaction or other groups that might be interested in sharing or selling censoring definitions for program content.

Similarly, a second input is received (step 350) and in response a second boundary is identified by capturing images or digests for one or more frames or the like (step 760). The first and second boundaries are associated as a boundary pair (step 370) and a determination is made of whether or not the previous boundary was the start point (step 375). If so, then the second boundary is saved as an end point (step 783). If not, then the second boundary is saved as a start point (step 784).

FIG. 8 illustrates an exemplary embodiment of the invention in which the first and second boundaries are time stamps. In this embodiment a time stamp is recorded onto a memory or other media with the program content, representing for example the time that the content was originally broadcast. In response to receiving a first input (step 330), the application sets a first boundary as the current time stamp (step 840). In response to receiving a second input (step 350), the application sets a second boundary as the current time stamp (step 860). The first and second boundaries are associated (step 370) to form a boundary pair and the boundaries are compared (step 875) to determine which is the earlier time stamp. If the first boundary is an earlier time stamp, then the first boundary is saved as a start point (step 882) and the second boundary is saved as an end point (step 884). If the second boundary is an earlier time stamp, then the second boundary is saved as a start point (step 886) and the first boundary is saved as an end point (step 888).

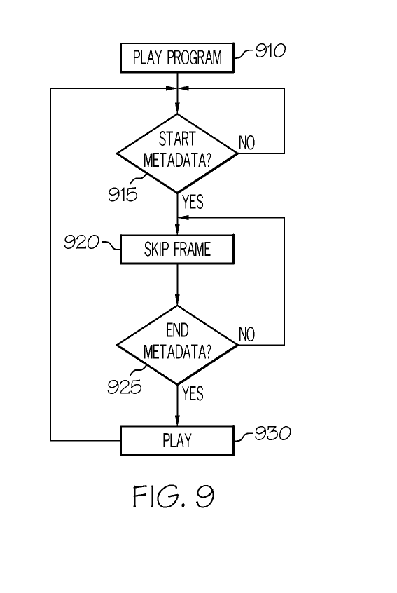

FIG. 9 illustrates a method for selectively skipping censored content while playing a program of audio, video or audiovisual content according to an exemplary embodiment of the invention. Play of the program is initiated (step 910). This may be accomplished, for example, by a user providing a play command through a remote control or other user interface to a device adapted to play programs such as a DVR, CD player, distributed network program provider, or the like.

While the program is playing, an apparatus or system executes an application for censoring programs, and the application checks each frame for start censoring metadata (step 915). If the frame does not contain the start censoring metadata, the program continues to play and the application continues to search for the start metadata. If the frame does contain the start metadata, then the application causes the program playing apparatus or system to skip the current frame (step 920) and the application begins checking each frame for end censoring metadata (step 925). If a frame does not have the end censoring metadata inserted onto it, then the application again causes the program playing apparatus or system to skip the current frame (step 920) and check the next frame for the end censoring metadata (step 925).

If the frame does contain the start censoring metadata in step 925, then the program resumes playing the program content (step 930), and the application again searches each frame for start censoring metadata (step 915). Thus, the program content is played to the end of the program with a variable number of portions of program content being censored so that the censored content is skipped and not played.

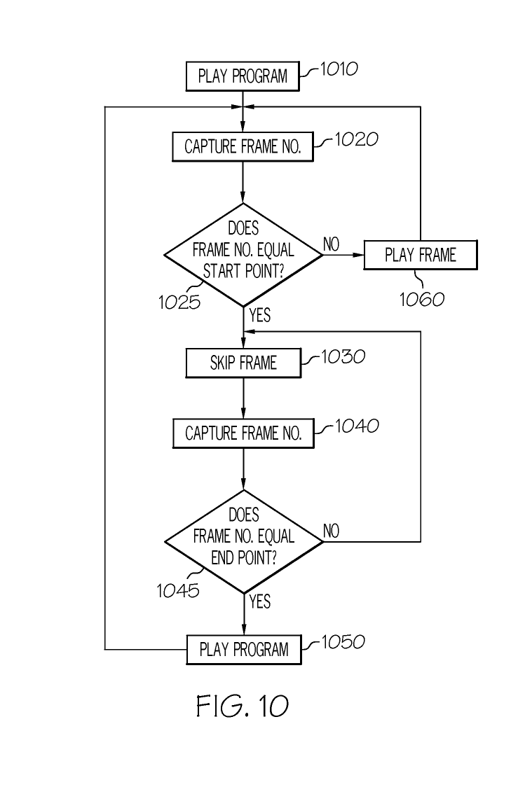

FIG. 10 illustrates an alternate method for selectively skipping censored content while playing a program of audio, video or audiovisual content according to an exemplary embodiment of the invention. As with the method of FIG. 9, an apparatus or system begins playing a program (step 1010). This step of beginning to play the program may be performed by the processor 130, 231 of FIGS. 1 and 2 respectively or independently of the processor.

If the censoring boundaries and start and end points are frame numbers, then an application executed by the processor 130 or 231, calculates or captures each frame number as that frame is displayed (step 1020). Similarly, if the boundaries and start and end points are time stamps, then a time stamp is calculated or captured, and if the boundaries and start and end points are images or digests, then an image is captured for each frame.

The application compares the calculated or captured attribute (e.g., frame number, time stamp, image, digest, etc) to the saved start point (step 1025). For example if the attribute is frame numbers as illustrated in FIG. 10, the application compares the current calculated or captured frame number to the frame number or frame numbers saved as start points. If the current calculated or captured frame number does not match a saved start point, then the application plays the frame (step 1060). The frame may be played, for example by transmitting the data or signal stream representing the frame to a display and/or speakers.

If the current calculated or captured frame number does match a saved start point, then the application skips the current frame (step 1030), meaning that the current frame is not played on the display/speakers. The application calculates or captures each subsequent frame number (step 1040) and compares the calculated or captured frame number to the saved end point (step 1045).

If the calculated or captured frame number matches the saved end point, then the application causes the program playing apparatus or system to resume playing the program (step 1050). That is, the current frame is displayed on a display, such as a television, speaker set, etc., and the application goes back to capturing frame numbers (step 1020) and comparing them to saved start points (step 1025).

If the calculated or captured frame number does not match the saved end point, then the application skips the frame (step 1030) and calculates or captures the next frame number (step 1040).

If the censoring boundaries and the start ad end points are time stamps, then the application compares the calculated or captured current time stamp to the saved start point time stamp. When a match is found the current frame of content is skipped and the application searches for the corresponding end point time stamp. Similarly, if the start point is an image or digest of one or more frames of content, then the application captures the current image or digest for one or more current frames and compares the captured images/digests to the saved start point. The comparison may use any of a number of known image matching methods. Again upon a match, the application skips the current frame and begins capturing attribute data (e.g., images/digests) and comparing them to the saved end point images/digests.

In an exemplary embodiment of the invention, a user can choose whether or not to display censored program content. For example, the user may be prompted by a menu when a censoring file is available for a selected program or when the program has been censored by insertion of metadata. The menu may allow a user to override the censoring by entering a password, for example. This password may be the same as a password used for blocking programs, such as a v-chip password or the like.

In an exemplary embodiment, the invention may be realized in the form of a machine program product comprising a machine readable media. Encoded on the machine program product are program instructions causing a machine to play a program of audiovisual content, to identify a first boundary in response to a first input, to identify a second boundary in response to a second input, to associate the first censoring boundary with the second censoring boundary, and to censor the content between the first boundary and the second boundary.

An exemplary embodiment of the invention may be realized in a machine program product comprising a machine readable media having encoded thereon: an identification of a start point adapted to cause a program playing device to begin skipping content of a program; and an identification of an end point adapted to cause a program playing device to resume playing content of the program. Such program product may be readily shared or distributed over the internet independently of the program content.

The foregoing drawing figures and descriptions are for illustrative purposes and are not intended as limitations. Rather variations and combinations of the features are intended within the scope of the invention.

What is claimed is:

1. A method for selectively censoring recorded program content while displaying a program, the method comprising the steps of:
in response to a first input, identifying a first boundary;
in response to a second input, identifying a second boundary; and
censoring the content between the first boundary and the second boundary.

2. The method of claim 1, wherein the program comprises a sequential series of frames, the boundaries are identified by frame number, the censoring boundary with the lower frame number is saved as a start point, and the censoring boundary with the higher frame number is saved as an end point.

3. The method of claim 1, wherein the boundaries are identified by time stamps, the earlier time stamp is saved as a start point, and the later time stamp is saved as an end point.

4. The method of claim 1 wherein the comprises a sequential series of frames, the boundaries are identified by frame number, the boundary with the lower frame number is identified as a start point, the boundary with the higher frame number is identified as an end point, and the start point and end point are identified by inserting metadata on the respective frames.

5. The method of claim 1, wherein the program comprises a sequential series of frames, the boundaries are identified by recording images or image digests from one or more frames, the boundary corresponding to earlier frames is saved as a start point, and the boundary corresponding to later frames is saved as an end point.

6. The method of claim 1 further comprising the steps of:
in response to a third input, identifying a third boundary;
in response to a fourth input, identifying a fourth boundary; and
censoring the content between the third censoring boundary and the fourth censoring boundary.

7. The method of claim 1 where an earlier one of the identified first and second boundaries is saved as a start point and a later one of the identified first and second boundaries is saved as an end point in a file containing the program.

8. The method of claim 1 where an earlier one of the identified first and second boundaries is saved as a start point and a later one of the identified first and second boundaries is saved as an end point in a file separate from the program.

9. A method for displaying a program excluding censored program content, comprising the steps of:
playing a program for which a start point and an end point for censoring are identified;
in response to reaching the start point, skipping program content;
in response to reaching the end point, resuming playing the program.

10. The method of claim 9, wherein the start point and end point are identified by metadata inserted in the program.

11. The method of claim 9, wherein the start point and end point are identified by frame numbers saved to a file.

12. The method of claim 9, wherein the start point and the end point are identified by saving one or more images or image digests; the step of skipping program content comprises matching the one or more images or image digests identified as the start point to the current frame or frames using image matching and, if the frame or frames match, skipping program content; the step of resuming playing the program comprises matching the one or more images or image digests identified as the end point to the current frame or frames using image matching and, if the frame or frames match, resuming playing the program.

13. The method of claim 9, wherein the start point and end point are identified by time stamps saved to a file.

14. The method of claim 9, wherein a user can choose whether or not to display censored program content.

15. The method of claim 14 wherein the censored content is password protected and the user can choose to view the censored content by entering a password.

16. An apparatus for recording and displaying programs excluding censored program content, the apparatus comprising:
a processor adapted to execute a program of instructions;
a program file of audiovisual content encoded on a memory; and
a program of instruction encoded on a memory and comprising the steps of: playing a program; in response to a first input, identifying a first boundary for censoring program content; in response to a second input, identifying a second boundary for censoring program content; determining which of said boundaries is a start point; and saving the boundaries as a start point and an end point.

17. The apparatus of claim 16, wherein the program file and the program of instruction are located on the same memory device.

18. The apparatus of claim 16, wherein the processor, and the memories are located in a digital video recording device.

19. The apparatus of claim 16, wherein the processor, and at least one memory are available through a distributed network.

20. The apparatus of claim 16, wherein the identified start point and the identified end point are saved in a file separate from the program content and accessible to the processor.

21. A machine program product comprising a machine readable media having encoded thereon:
a first program instruction to play a program;
a second program instruction to identify a first boundary in response to a first input;
a third program instruction to identify a second boundary in response to a second input;
a fourth program instruction to associate the first censoring boundary with the second censoring boundary; and
a fifth program instruction to censor the content between the first boundary and the second boundary.

22. A machine program product comprising a machine readable media having encoded thereon:
an identification of a start point adapted to cause a program playing device to begin skipping content of a program; and
an identification of an end point adapted to cause a program playing device to resume playing content of the program.

23. The machine program product of claim 22, wherein the machine readable media further comprises the program content.

24. The machine program product of claim 22, wherein the identification of a start point and the identification of an end point comprise metadata inserted in the program at frames corresponding to the start point and the end point.

25. The machine program product of claim 22, wherein the identification of a start point and the identification of an end point comprise one or more images or image digests; and the machine program product uses an image matching application to locate the start point and the end point for censoring.
